(19) United States
(12) Patent Application Publication
(10) Pub. No.: US 2022/0123290 A1
(43) Pub. Date: Apr. 21, 2022

(54) Composition for Anode of Lithium Secondary Battery and Lithium Secondary Battery Manufactured Using the Same

(71) Applicant: SK Innovation Co., Ltd., Seoul (KR)

(72) Inventors: Ju Ho Chung, Daejeon (KR); Joon Sup Kim, Daejeon (KR); Gwi Ok Park, Daejeon (KR); Eun Jun Park, Daejeon (KR); Kyeong Hyeon Kang, Daejeon (KR); Joon Hyung Moon, Daejeon (KR)

(21) Appl. No.: 17/506,908

(22) Filed: Oct. 21, 2021

(30) Foreign Application Priority Data
Oct. 21, 2020 (KR) 10-2020-0136611

(51) Int. Cl. H01M 4/48; H01M 10/0525; H01M 4/131; H01M 4/36; H01M 4/62; H01M 4/66

(52) U.S. Cl. CPC H01M 4/48; H01M 10/0525; H01M 4/131; H01M 2004/021; H01M 4/622; H01M 4/662; H01M 4/366

(57) ABSTRACT

An anode composition for a lithium secondary battery according to an embodiment of the present invention includes a metal-doped silicon oxide (SiOx, 0<x<2) particle satisfying Equation 1 and including a metal silicate area on a surface portion thereof, and an organic acid. Thus, gas generation and viscosity change rate of the composition are reduced to improve life-span property.

### CROSS-REFERENCE TO RELATED APPLICATION

This application claims priority to Korean Patent Application No. 10-2020-0136611 filed on Oct. 21, 2020, the entire disclosure of which is incorporated by reference in its entirety.

### BACKGROUND

### 1. Field of the Invention

The present invention relates to a composition for an anode of lithium secondary battery and a lithium secondary battery manufactured using the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle such as an electric automobile.

The secondary battery includes, e.g., a lithium secondary battery, a nickel-cadmium battery, a nickel-hydrogen battery, etc. The lithium secondary battery is highlighted due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The lithium secondary battery may further include an outer case having, e.g., a pouch shape.

Recently, as an application of the lithium secondary battery is expanded, the lithium secondary battery having higher capacity and power is being developed. Particularly, silicon oxide (SiOx) having a high capacity may be used for an anode active material. However, silicon oxide has a low efficiency, and thus may not provide sufficient energy density.

Accordingly, a metal is doped in silicon oxide to increase the efficiency of silicon oxide. For example, Korean Registered Patent Publications Nos. 10-1591698 and 10-1728171 disclose anode active materials in which silicon oxide is doped with metal (lithium), but slurry property and sufficient power may not be provided.

When silicon oxide is doped with the metal, viscosity may be lowered during a preparation of an anode slurry and gas generation may be caused to degrade power of a battery.

### SUMMARY OF THE INVENTION

According to an aspect of the present invention, there is provided a composition for an anode of a lithium secondary battery having improved power and capacity efficiency.

According to an aspect of the present invention, there is provided a lithium secondary battery fabricated using a composition for an anode with improved power and capacity efficiency.

According to exemplary embodiments, an anode composition for a lithium secondary battery includes a metal-doped silicon oxide (SiOx, 0<x<2) particle satisfying Equation 1 and including a metal silicate area on a surface portion thereof, and an organic acid:

A/B≤16.0 [Equation 1]

In Equation 1, A is a peak area corresponding to a metal silicate from a deconvolution of an Si2p spectrum measured by an X-ray Photoelectron Spectroscopy (XPS) analysis on the metal-doped silicon oxide (SiOx, 0<x<2) particle. B is a peak area corresponding to silicon dioxide from the deconvolution of the Si2p spectrum measured by the XPS analysis on the metal-doped silicon oxide (SiOx, 0<x<2) particle. A peak area at 102 eV corresponds to the peak area of the metal silicate and a peak area at 104 eV corresponds to the peak area of silicon dioxide.

In some embodiments, a metal doped to the metal-doped silicon oxide (SiOx, 0<x<2) particle may include at least one selected from the group consisting of lithium, magnesium, calcium and aluminum.

In some embodiments, the organic acid may include at least one selected from the group consisting of maleic acid, palmitic acid, tartaric acid, acetic acid, methacrylic acid, glycolic acid, oxalic acid, glutaric acid and fumaric acid.

In some embodiments, a content of the organic acid may be from 0.5 wt % to 1.5 wt % based on a total weight of the anode composition.

In some embodiments, the content of the organic acid may be from 0.6 wt % to 1.2 wt % based on the total weight of the anode composition.

In some embodiments, a pH of the anode composition may be from 7.0 to 9.5.

In some embodiments, the anode composition may further include a binder and a thickener.

In some embodiments, the binder may include at least one of an acrylic binder and styrene-butadiene rubber (SBR).

In some embodiments, the thickener may include carboxymethyl cellulose (CMC).

In a method of preparing an anode composition for a lithium secondary battery according to exemplary embodiments, a metal-doped silicon oxide (SiOx, 0<x<2) particle is prepared. An organic acid is mixed with the metal-doped silicon oxide (SiOx, 0<x<2) particle. A binder and a thickener are mixed to the metal-doped silicon oxide (SiOx, 0<x<2) particle mixed with the organic acid.

In some embodiments, an X-ray Photoelectron Spectroscopy (XPS) analysis may be performed on the metal-doped silicon oxide (SiOx, 0<x<2) particle. The organic acid may be mixed when the metal-doped silicon oxide (SiOx, 0<x<2) particle may satisfy Equation 1:

A/B≤16.0 [Equation 1]

In Equation 1, A is a peak area corresponding to a metal silicate from a deconvolution of an Si2p spectrum measured by the XPS analysis on the metal-doped silicon oxide (SiOx, 0<x<2) particle. B is a peak area corresponding to silicon dioxide from the deconvolution of the Si2p spectrum measured by the XPS analysis on the metal-doped silicon oxide (SiOx, 0<x<2) particle. A peak area at 102 eV corresponds to the peak area of the metal silicate and a peak area at 104 eV corresponds to the peak area of silicon dioxide.

In some embodiments, an acid washing may not be performed in the preparation of the metal-doped silicon oxide (SiOx, 0<x<2) particle.

According exemplary embodiments, an anode for a lithium secondary battery includes an anode current collector, and an anode active material layer formed by coating an anode composition on at least one surface of the anode current collector. The anode composition includes a metal-doped silicon oxide (SiOx, 0<x<2) particle satisfying Equation 1 and including a metal silicate area on a surface portion thereof, and an organic acid:

A/B≤16.0 [Equation 1]

In Equation 1, A is a peak area corresponding to a metal silicate from a deconvolution of an Si2p spectrum measured by the XPS analysis on the metal-doped silicon oxide (SiOx, 0<x<2) particle. B is a peak area corresponding to silicon dioxide from the deconvolution of the Si2p spectrum measured by the XPS analysis on the metal-doped silicon oxide (SiOx, 0<x<2) particle. A peak area at 102 eV corresponds to the peak area of the metal silicate and a peak area at 104 eV corresponds to the peak area of silicon dioxide.

In a composition for an anode of a lithium secondary battery according to exemplary embodiments, a peak area ratio between a metal silicate and silicon dioxide (SiO₂) obtained from a deconvolution of an Si2p spectrum measured by an XPS (X-ray Photoelectron Spectroscopy) analysis is 16.0 or less. Accordingly, degradation of a battery capacity due to an excessive metal doping may be prevented.

In exemplary embodiments, an organic acid may be included in the composition for an anode. Accordingly, hydroxide ions may be removed to prevent an increase in pH of the composition, suppress generation of a hydrogen gas and block a reaction with silicon in an anode active material, thereby improving battery life-span and capacity.

In a method of preparing the anode composition according to some embodiments, an addition of the organic acid may be performed before adding and mixing a binder, a thickener, or the like. In this case, the organic acid may be mixed before the anode active material is in contact with water to prevent hydroxide ions generated when the anode active material is in contact with water from reacting with silicon of the anode active material. Accordingly, deterioration of the battery capacity may be prevented.

In some embodiments, an acid washing process may not be included in the preparation of the anode composition. In this case, a pH increase and hydrogen gas generation in the anode composition due to the addition of the organic acid may be prevented to improve power/capacity properties and life-span of the battery while reducing a process cost and implementing an eco-friendly process. Further, reduction of an initial capacity efficiency due to a removal of a residual metal may be prevented.

### BRIEF DESCRIPTION OF THE DRAWINGS

FIG. 1 is a process flow diagram for describing a method of preparing a composition for an anode in accordance with exemplary embodiments.

FIGS. 2 and 3 are a schematic top planar view and a cross-sectional view, respectively, illustrating a lithium secondary battery in accordance with exemplary embodiments.

### DETAILED DESCRIPTION OF THE EMBODIMENTS

According to exemplary embodiments of the present invention, a composition for an anode of a lithium secondary battery (hereinafter, abbreviated as an anode composition) including a silicon-based active material is provided. Further, an anode of a lithium secondary battery and a lithium secondary battery fabricated using the anode composition are also provided

In exemplary embodiments, the anode composition may be provided in the form of a slurry and may include an anode active material, a binder, a conductive material and a thickener.

The anode active material may include a silicon oxide (SiOx, 0<x<2) particle.

In exemplary embodiments, the silicon oxide (SiOx, 0<x<2) particle may be doped with a metal to improve an initial efficiency of a lithium secondary battery,

For example, when the silicon oxide (SiOx, 0<x<2) particle is doped with a metal component, the metal may bind to the silicon oxide (SiOx, 0<x<2) particle and may cause an irreversible reaction to form a metal silicate region on a surface portion of the particle. In this case, for example, an initial irreversible reaction of the silicon oxide particle may be reduced in a lithium-ion insertion and desorption process during charge and discharge of the battery. Accordingly, an initial efficiency of the lithium secondary battery may be improved.

In some embodiments, the metal doped in the silicon oxide (SiOx, 0<x<2) particle may include at least one of lithium (Li), magnesium (Mg), calcium (Ca) and aluminum (Al).

For example, the silicon oxide (SiOx, 0<x<2) particle including the lithium compound may be the silicon oxide (SiOx, 0<x<2) particle including lithium silicate. Lithium silicate may be present in at least a portion of the silicon oxide (SiOx, 0<x<2) particle. For example, lithium silicate may be present at an inside and/or on a surface of the silicon oxide (SiOx, 0<x<2) particle. In an embodiment, lithium silicate may include Li₂SiO₃, Li₂Si₂O₅, Li₄SiO₄, Li₄Si₃O₈, or the like.

In exemplary embodiments, the metal-doped silicon oxide (SiOx, 0<x<2) particle may be used as an anode active material, and a peak area ratio of a metal silicate and silicon dioxide (SiO₂) measured by an XPS analysis on the silicon oxide (SiOx, 0<x<2) particle may satisfy Equation 1 below.

A/B≤16.0 [Equation 1]

In Equation 1, A is a peak area corresponding to the metal silicate from a deconvolution of an Si₂p spectrum measured by the XPS analysis on the silicon oxide (SiOx, 0<x<2) particle. B is a peak area corresponding to silicon dioxide from the deconvolution of the Si₂p spectrum measured by the XPS analysis on the silicon oxide (SiOx, 0<x<2) particle.

For example, silicon dioxide may be produced by an irreversible conversion of silicon in a hydrogen gas generation reaction due to a reaction between a hydroxide ion and silicon, which will be described later. Accordingly, a capacity of the active material may be decreased and a capacity property of the battery may be deteriorated.

For example, after the deconvolution of the Si₂p spectrum obtained by the XPS analysis on the metal-doped silicon oxide (SiOx, 0<x<2) particle, a 102 eV peak area is taken as the peak area of the metal silicate, a 104 eV peak area is taken as the peak area of silicon dioxide, and the peak area ratio of the metal silicate and silicon dioxide may be calculated.

In some embodiments, the peak area ratio of the metal silicate and silicon dioxide measured by the XPS analysis with respect to the metal-doped silicon oxide (SiOx, 0<x<2) particle may be from 0.5 to 16. In the above range, deterioration of the capacity property caused by an excessive metal doping may be prevented while also preventing a deterioration of the capacity property caused by an excessive increase of a silicon dioxide content.

For example, if the peak area ratio of the metal silicate and silicon dioxide represented as Equation 1 exceeds 16.0, a ratio of the metal silicate area of the metal-doped silicon oxide (SiOx, 0<x<2) particle may increases and a generation of a hydrogen gas as will be described later may not be caused. Accordingly, an addition of an organic acid may not be needed.

However, due to an excessive metal doping, a lithium-ion intercalation/desorption function of the silicon oxide (SiOx, 0<x<2) particle may be deteriorated, and thus the capacity property of the battery may also be deteriorated.

If the peak area ratio of the metal silicate and silicon dioxide represented as Equation 1 is 16.0 or less, the capacity property of the battery may not be deteriorated, but issues regarding fabrication of the battery, slurry storage, etc., may occur.

For example, a metal hydroxide (e.g., LiOH or Mg(OH)₂) may be formed on the surface of the silicon oxide (SiOx, 0<x<2) particle. In this case, the metal hydroxide may react with water to form a hydroxide ion (OH—), thereby increasing a pH of the anode composition. Accordingly, a thickener may shrink and a viscosity of the anode composition may decrease, thereby degrade processability and productivity during an electrode fabrication. Further, as the metal hydroxide on the surface of the silicon oxide (SiOx, 0<x<2) particle is removed, improved battery efficiency from the metal doping may not be implemented.

For example, the hydroxide ion may react with silicon to generate the hydrogen gas (H₂ gas). In this case, a reversible phase of silicon may be converted into an irreversible phase of silicon oxide (e.g., SiO₂), and thus the capacity property of the anode active material may be deteriorated.

In exemplary embodiments, the organic acid may be included in the anode composition. Thus, even when the peak area ratio of the metal silicate and silicon dioxide represented as Equation 1 is 16.0 or less, the organic acid may prevent the increase of the pH of the anode composition, thereby preventing the thickener from shrinking. Accordingly, a decrease of the viscosity of the anode composition may be suppressed and a decrease in processability and productivity during the electrode fabrication may also be avoided.

For example, the organic acid may be dissolved in water to react with the hydroxide ion, so that a concentration of the hydroxide ion may be reduced. Accordingly, the reaction of silicon with the hydroxide ion may be prevented and the generation of hydrogen gas may be avoided or reduced.

In some embodiments, the organic acid may include at least one of maleic acid, palmitic acid, tartaric acid, acetic acid, methacrylic acid, glycolic acid, oxalic acid, glutaric acid and fumaric acid.

In some embodiments, a content of the organic acid based on a total weight of the anode composition may be from 0.5 weight percent (wt %) to 1.5 wt %, preferably from 0.6 wt % to 1.2 wt %.

For example, in the above content range, the pH of the anode composition may be effectively lowered, and the capacity property and an initial capacity efficiency may be improved while suppressing gas generation.

For example, if the content of the organic acid is excessively low, the reaction between silicon and the hydroxide ion may not be sufficiently suppressed, so that the gas generation and reduction of a power property may be caused.

For example, if the content of the organic acid is excessively increased, the organic acid and the hydroxide ion may not be sufficiently reacted with each other. Accordingly, power/capacity properties of the battery and life-span property during repeated charging and discharging may be deteriorated.

In some embodiments, the pH of the anode composition may be adjusted in a range from 7.0 to 9.5 by the addition of the organic acid in the above proper range.

In some embodiments, the anode composition may further include a solvent, a binder, a conductive material and a thickener.

For example, the solvent may be a non-aqueous solvent. The non-aqueous solvent may include, e.g., N-methyl-2-pyrrolidone (NMP), dimethylformamide, dimethylacetamide, N,N-dimethylaminopropylamine, ethylene oxide, tetrahydrofuran, or the like.

For example, the binder may include at least one of an organic binder such as polyacrylonitrile and polymethylmethacrylate, or an aqueous binder such as styrene-butadiene rubber (SBR).

For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

For example, the thickener may include a carboxymethyl cellulose (CMC).

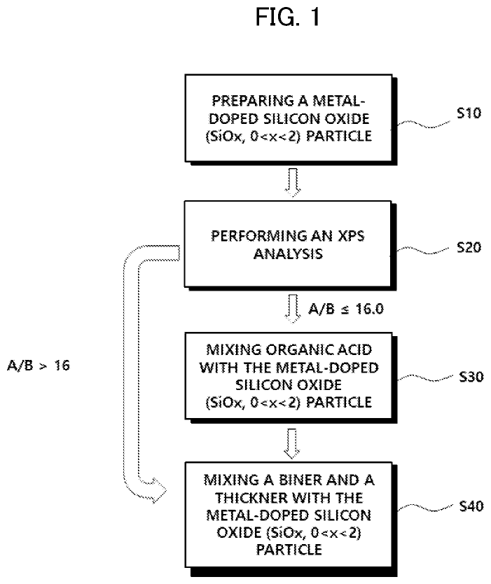

FIG. 1 is a process flow diagram for describing a method of preparing a composition for an anode in accordance with exemplary embodiments.

Hereinafter, a method of preparing the above-described anode composition for a lithium secondary battery is described with reference to FIG. 1.

Referring to FIG. 1, a metal doping may be performed on a surface portion of a silicon oxide (SiOx, 0<x<2) particle to form a metal-doped silicon oxide (SiOx, 0<x<2) particle (e.g., in an operation of S10).

In some embodiments, an XPS analysis may be performed on the prepared metal-doped silicon oxide (SiOx, 0<x<2) particles (e.g., in an operation of S20).

For example, after deconvolution of a Si₂p spectrum obtained by the XPS analysis on the prepared metal-doped silicon oxide particle, a peak area ratio of a metal silicate and silicon dioxide may be calculated. In the calculation, an 102 eV peak area corresponds to a peak area of the metal silicate, and an 104 eV peak area corresponds to a peak area of silicon dioxide.

For example, if the peak area ratio of the metal silicate and silicon dioxide in the metal-doped silicon oxide (SiOx, 0<x<2) particle measured through the XPS analysis does not satisfy Equation 1 (e.g., A/B>16.0), a ratio of the metal silicate area in the metal-doped silicon oxide (SiOx, 0<x<2) particle may increase. Thus, the generation of the hydrogen gas may not occur, and the introduction of the organic acid to be described later may be omitted.

For example, if the peak area ratio of the metal silicate and silicon dioxide in the metal-doped silicon oxide (SiOx, 0<x<2) particle measured through the XPS analysis satisfies Equation 1 (e.g., A/B≤16.0), the hydroxide ion may be generated and the viscosity may be decreased as the pH of the anode composition increases. Further, the reaction between silicon and the hydroxide ion may occur to cause a capacity reduction and generation of the hydrogen gas.

In some embodiments, if the peak area ratio of the metal silicate and silicon dioxide in the metal-doped silicon oxide (SiOx, 0<x<2) particle measured through he XPS analysis satisfies Equation 1, an organic acid may be mixed with the prepared metal-doped silicon oxide (SiOx, 0<x<2) particle to overcome the above-described issue (e.g., in an operation of S30).

For example, the organic acid may be directly mixed with the prepared metal-doped silicon oxide (SiOx, 0<x<2) particle. In this case, the organic acid may be mixed before a metal hydroxide present on a surface of the metal-doped silicon oxide (SiOx, 0<x<2) particle react with water to prevent a hydroxide ion generated by the reaction of the metal hydroxide with water being reacting with silicon of the metal-doped silicon oxide (SiOx, 0<x<2) particle. Accordingly, the generation of the hydrogen gas caused by the reaction may be suppressed to prevent deterioration of the capacity property of the battery.

In exemplary embodiments, in, e.g., an operation of S40, a solvent, a binder, a conductive material and a thickener may be mixed with the metal-doped silicon oxide (SiOx, 0<x<2) particle mixed with the organic acid to form am anode composition.

The solvent, the binder, the conductive material and the thickener may include the materials as described above.

For example, the step of preparing the metal-doped silicon oxide (SiOx, 0<x<2) particle may further include washing with a strong acid in order to suppress an increase of the pH of the anode composition and the generation of hydrogen gas. However, in this case, a process cost may be excessively increased, and an environmental pollution may be caused. Further, the doped metal formed for increasing a cell efficiency may be removed due to the acid washing, and thus an initial capacity efficiency may be degraded.

In some embodiments, the method for preparing the above-described anode composition for a lithium secondary battery may not include the acid washing process. In this case, the process cost may be reduced and an eco-friendly process may be implemented while improving the power/capacity properties and life-span properties by suppressing the pH increase and the generation of hydrogen gas of the anode composition through the addition of the organic acid. Further, the degradation of the initial capacity efficiency caused by the removal of the doped metal may be prevented.

In some embodiments, the metal doping may be performed after formation of the metal-doped silicon oxide (SiOx, 0<x<2) particle. In this case, a content of the metal silicate content present on the surface of the metal-doped silicon oxide (SiOx, 0<x<2) particle may be controlled to be less than or equal to a predetermined value.

For example, the peak area ratio of the metal silicate and silicon dioxide measured by the XPS analysis according to Equation 1 may be 16 or less. Accordingly, the capacity property of the battery may be improved by preventing deterioration of the lithium ion insertion/desorption function of silicon dioxide.

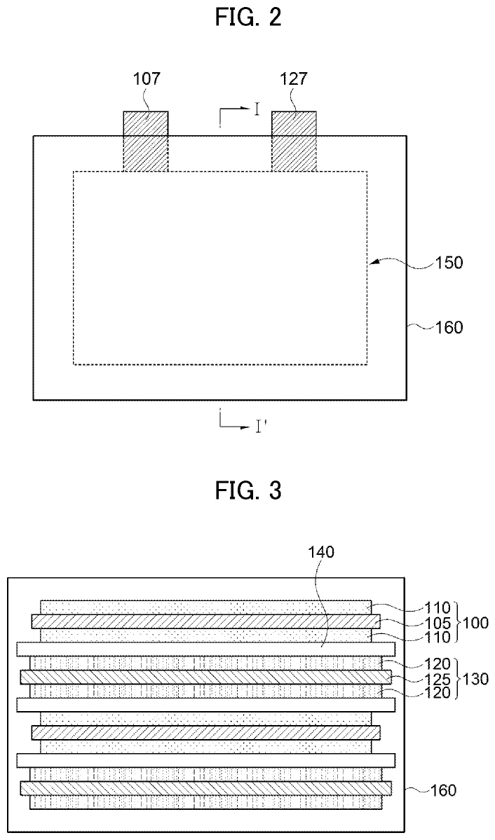

FIGS. 2 and 3 are a schematic top planar view and a cross-sectional view, respectively, illustrating a lithium secondary battery in accordance with exemplary embodiments.

Hereinafter, a lithium secondary battery including an anode formed from the above-described anode composition is described with reference to FIGS. 2 and 3.

Referring to FIGS. 2 and 3, the lithium secondary battery may include an electrode assembly including a cathode 100, an anode 130 and a separation layer 140 interposed between the cathode and the anode. The electrode assembly may be accommodated and impregnated with an electrolyte in a case 160.

The cathode 100 may include a cathode active material layer 110 formed by coating a slurry containing a cathode active material on the cathode current collector 105.

The cathode current collector 105 may include aluminum or an aluminum alloy; stainless-steel, nickel, titanium or an alloy thereof; aluminum or stainless-steel surface-treated with carbon, nickel, titanium, silver or the like, etc.

The cathode active material may include a compound capable of reversibly intercalating and de-intercalating lithium ions.

In exemplary embodiments, the cathode active material may include a lithium-transition metal oxide. For example, the lithium-transition metal oxide may include nickel (Ni), and may further include at least one of cobalt (Co) and manganese (Mn).

For example, the lithium-transition metal oxide may be represented by Chemical Formula 1 below.

LiₓNi_{1-y}M_{y}O_{2+z} [Chemical Formula 1]

In Chemical Formula 1, 0.9≤x≤1.1, 0≤y≤0.7, −0.1≤z≤0.1. M may be at least one element selected from Na, Mg, Ca, Y, Ti, Zr, Hf, V, Nb, Ta, Cr, Mo, W, Mn, Co, Fe, Cu, Ag, Zn, B, Al, Ga, C, Si, Sn and Zr.

In some embodiments, 1-y in Chemical Formula 1 (i.e., a molar ratio or concentration of Ni) may be 0.8 or more, and may exceed 0.8 in preferred embo

A slurry may be prepared by mixing and stirring the cathode active material with a binder, a conductive material and/or a dispersive agent in a solvent. The slurry may be coated on the cathode current collector 105, dried and pressed to form the cathode 100.

The solvent may include a non-aqueous solvent. The non-aqueous solvent may include, e.g., N-methyl-2-pyrrolidone (NMP), dimethylformamide, dimethylacetamide, N,N-dimethylaminopropylamine, ethylene oxide, tetrahydrofuran, etc.

The binder may include, e.g., an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer 110 may be reduced, and an amount of the cathode active material may be relatively increased. Thus, capacity and power of the lithium secondary battery may be further improved.

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

In exemplary embodiments, the above-described anode composition may be coated on at least one surface of an anode current collector 125, dried and pressed to form an anode active material layer.

The anode current collector 125 may include, e.g., a metal having high conductivity and adhesion to the anode composition and being non-reactive in a voltage range of the battery. For example, the anode current collector 125 may include copper or a copper alloy; stainless-steel, nickel, titanium or an alloy thereof; copper or stainless-steel surface-treated with carbon, nickel, titanium, silver or the like, etc.

The separation layer 140 may be interposed between the cathode 100 and the anode 130. The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like.

In some embodiments, an area and/or a volume of the anode 130 (e.g., a contact area with the separation layer 140) may be greater than that of the cathode 100. Thus, lithium ions generated from the cathode 100 may be easily transferred to the anode 130 without a loss by, e.g., precipitation or sedimentation. Thus, improvement of the capacity and power may be more efficiently promoted from the anode active material including the above-described the metal-doped silicon oxide (SiOx, 0<x<2) particle.

In exemplary embodiments, an electrode cell may be defined by the cathode 100, the anode 130 and the separation layer 140, and a plurality of the electrode cells may be stacked to form the electrode assembly 150 that may have e.g., a jelly roll shape. For example, the electrode assembly 150 may be formed by winding, laminating or folding the separation layer 140.

The electrode assembly 150 may be accommodated together with the electrolyte in the case 160 to define the lithium secondary battery. In exemplary embodiments, a non-aqueous electrolyte may be used as the electrolyte.

For example, the non-aqueous electrolyte may include a lithium salt and an organic solvent. The lithium salt may be represented by Li⁺X⁻. An anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination thereof.

As illustrated in FIG. 2, an electrode tab (a cathode tab and an anode tab) may be formed from each of the cathode current collector 105 and the anode current collector 125 to extend to one end of the case 160. The electrode tabs may be welded together with the one end of the case 160 to form an electrode lead (a cathode lead 107 and an anode lead 127) exposed at an outside of the case 160.

The lithium secondary battery may be fabricated into a cylindrical shape using a can, a prismatic shape, a pouch shape, a coin shape, etc.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Example 1

Preparation of Anode

Li was doped to a synthesized silicon oxide (SiOx, 0<x<2) particle to prepare a metal-doped silicon oxide (SiOx, 0<x<2) particle including a metal silicate area on a surface thereof (in an operation of S10).

An XPS peak area ratio of a metal silicate and silicon dioxide (SiO₂) was calculated according to Experimental Example as will be described below to confirm a value of 16.0 or less (in an operation of S20).

Maleic acid was mixed with the metal-doped silicon oxide (SiOx, 0<x<2) particle with an amount of 1.0 wt % based on a total weight of the anode composition (in an operation of S30).

95.5 wt % of the mixture of maleic acid and the metal-doped silicon oxide (SiOx, 0<x<2) particle, 1 wt % of CNT as a flake-type conductive material, 2 wt % of styrene-butadiene rubber (SBR) and 1.5 wt % of carboxymethyl cellulose (CMC) as a thickener were mixed to obtain an anode composition (in an operation of S40).

The anode composition was coated on a copper substrate, dried and pressed to prepare an anode.

Preparation of Li-Half Cell

A lithium secondary battery including the above-prepared anode and a Li-foil as a counter electrode (cathode) was fabricated.

Specifically, a separation layer (polyethylene, thickness: 20 μm) was interposed between the anode and the Li-foil (thickness: 2 mm) to form a Li-coin half cell.

The assembly of Li-foil/separation layer/anode was put in a coin cell plate, capped after an injection of an electrolyte solution, and the clamped. An 1M LiPF₆ electrolyte solution dissolved in a mixed solvent of EC/FEC/EMC/DEC (20/10/20/50; volume ratio) was used. An impregnation for 12 hours more was performed after the clamping, and 3 cycles of charging and discharging was performed (Charging condition: CC-CV 0.1C 0.01V 0.01C CUT-OFF, Discharging condition: CC 0.1C 1.5V CUT-OFF).

### Example 2

An anode and a lithium secondary battery including the anode were fabricated by the same method as that in Example 1, except that the amount of maleic acid was changed to be 0.7 wt % based on a total weight of the anode composition.

### Example 3

An anode and a lithium secondary battery including the anode were fabricated by the same method as that in Example 1, except that the amount of maleic acid was changed to be 1.5 wt % based on a total weight of the anode composition.

### Example 4

An anode and a lithium secondary battery including the anode were fabricated by the same method as that in Example 1, except that the amount of maleic acid was changed to be 1.2 wt % based on a total weight of the anode composition.

### Example 5

An anode and a lithium secondary battery including the anode were fabricated by the same method as that in Example 1, except that 94.5 wt % of the prepared metal-doped silicon oxide (SiOx, 0<x<2) particle without being mixed with maleic acid, 1 wt % of CNT and 1.5 wt % of CMC were mixed and stirred for 120 minutes, and then 1.0 wt % of maleic acid and 2.0 wt % of SBR were mixed to form an anode composition.

### Example 6

An anode and a lithium secondary battery including the anode were fabricated by the same method as that in Example 1, except that the amount of maleic acid was changed to be 1.6 wt % based on a total weight of the anode composition.

### Example 7

An anode and a lithium secondary battery including the anode were fabricated by the same method as that in Example 1, except that the amount of maleic acid was changed to be 0.4 wt % based on a total weight of the anode composition.

### Comparative Example 1

An anode and a lithium secondary battery including the anode were fabricated by the same method as that in Example 1, except that the XPS peak area ratio exceeded 16.0 in the metal-doped silicon oxide (SiOx, 0<x<2) particle preparation and maleic acid was not mixed.

### Comparative Example 2

An anode and a lithium secondary battery including the anode were fabricated by the same method as that in Example 1, except that maleic acid was not mixed with the metal-doped silicon oxide (SiOx, 0<x<2) particle.

### Comparative Example 3

An anode and a lithium secondary battery including the anode were fabricated by the same method as that in Example 1, except that maleic acid was not added and the metal-doped silicon oxide (SiOx, 0<x<2) particles were washed with hydrochloric acid (HCl) in the preparation of the particles.

### Experimental Example

(1) Evaluation of XPS Peak Area Ratio of Metal Silicate and Silicon Dioxide (SiO₂)

After deconvolution of a Si2p spectrum obtained by an XPS analysis of the anode compositions prepared according to the above-described Examples and Comparative Examples, an 102 eV peak area was measured as a peak area of the metal silicate, and an 104 eV peak area was measured as a peak area of silicon dioxide.

The peak area ratio was evaluated by dividing the calculated peak area of the metal silicate by the peak area of silicon dioxide.

(2) Evaluation of Organic Acid (Maleic Acid) Content

When preparing the anode composition according to the above-described Examples and Comparative Examples, the added amount of maleic acid was evaluated as the organic acid (maleic acid) content of the anode composition.

(3) Measurement of pH

The pH values of the anode compositions prepared according to the above-described Examples and Comparative Examples were measured using a pH meter (CAS Benchtop pH tester PM-3).

(4) Phase of Adding Organic Acid

The adding phases of the organic acid were categorized as follows and shown in Table 1.

First mixing: Maleic acid was mixed with the prepared metal-doped silicon oxide (SiOx, 0<x<2) particle immediately after the step of preparing the metal-doped silicon oxide (SiOx, 0<x<2) particle.

Second mixing: 94.5 wt % of the prepared metal-doped silicon oxide (SiOx, 0<x<2) particle, 1.0 wt % of CNT and 1.5 wt % of CMC were added and stirred for 120 minutes, and then 1.0 wt % of maleic acid and 2.0 wt % of SBR were mixed.

(5) Measurement of Viscosity and Viscosity Change Rate of the Composition

An initial viscosity of each anode composition prepared according to the above-described Examples and Comparative Examples was measured, a viscosity of the anode composition was measured after 7 days (Programmable Digital Viscometer DV-II+pro, Brookfield Co.).

A composition viscosity change rate was evaluated by dividing the value obtained by subtracting the viscosity after 7 days from the initial viscosity by the initial viscosity.

(6) Gas Generation Amount

The anode compositions prepared according to the above-described Examples and Comparative Examples were stored in a chamber at 25° C., and an amount of gas generated after 3 days was detected by a gas chromatography (GC) analysis. A hole was formed in the vacuum chamber having a predetermined volume (V) for measuring a total amount of gas generation, and a volume of a generated gas was calculated by measuring a pressure change.

(7) Measurement of Initial Charge/Discharge Capacity and Initial Capacity Efficiency

The lithium secondary batteries prepared according to the above-described Examples and Comparative Examples were charged (CC-CV 0.1C 0.01V 0.01C CUT-OFF) in a chamber at 25° C., and then a battery capacity (initial charge capacity) was measured. Thereafter, the batteries were discharged (CC 0.1C 1.5V CUT-OFF), and then a battery capacity (initial discharge capacity) was measured.

An initial capacity efficiency was calculated as a percentage by dividing the measured initial discharge capacity by the measured initial charge capacity.

(8) Measurement of Capacity Retention Ratio

The lithium secondary batteries prepared according to the above-described Examples and Comparative Examples were charged (CC-CV 0.3C 0.01V 0.01C CUT-OFF) and discharged (CC 0.5C 1.0V CUT-OFF) 50 times at 25° C. chamber. A capacity retention was calculated as a percentage by dividing a discharge capacity at 50th cycle by an initial discharge capacity.

The evaluation results are shown in Tables 1 to 3.

TABLE 1

| | XPS peak | XPS peak | | | | |
|---|---|---|---|---|---|---|
| | area of | area of | | Content of | | Phase of |
| | metal | silicon | XPS peak | organic acid | | adding |
| | silicate | dioxide | area ratio | (wt %) | pH | organic acid |
| Example 1 | 546 | 41 | 13.4 | 1.0 | 9.1 | first mixing |
| Example 2 | 546 | 41 | 13.4 | 0.7 | 9.4 | first mixing |
| Example 3 | 546 | 41 | 13.4 | 1.5 | 7.0 | first mixing |
| Example 4 | 546 | 41 | 13.4 | 1.2 | 8.3 | first mixing |
| Example 5 | 546 | 41 | 13.4 | 1.2 | 8.0 | second mixing |
| Example 6 | 546 | 41 | 13.4 | 1.6 | 6.8 | first mixing |
| Example 7 | 546 | 41 | 13.4 | 0.4 | 10.6 | first mixing |
| Comparative | 1068 | 65 | 16.3 | 0 | 8.4 | — |
| Example 1 | | | | | | |
| Comparative | 546 | 41 | 13.4 | 0 | 12.3 | — |
| Example 2 | | | | | | |
| Comparative | 546 | 41 | 13.4 | 0 | 8.5 | — |
| Example 3 | | | | | | |

TABLE 2

| | | Viscosity | Viscosity | |
|---|---|---|---|---|
| | Initial | after | change | Generated |
| | Viscosity | 7 days | rate | Gas |
| | (cp) | (cp) | (%) | (mL) |
| Example 1 | 21,030 | 19,880 | 5 | 0 |
| Example 2 | 18,120 | 15,050 | 17 | 4 |
| Example 3 | 24,550 | 23,890 | 3 | 0 |
| Example 4 | 22,750 | 21,610 | 5 | 0 |
| Example 5 | 23,160 | 21,770 | 6 | 0 |
| Example 6 | 25,350 | 24,840 | 2 | 0 |
| Example 7 | 17,630 | 14,280 | 19 | 7 |
| Comparative | 21,530 | 19,800 | 8 | 0 |
| Example 1 | | | | |
| Comparative | 16,650 | 10,900 | 35 | 10 |
| Example 2 | | | | |
| Comparative | 26,330 | 25,800 | 2 | 0 |
| Example 3 | | | | |

TABLE 3

| | Initial | Initial | Initial | |
|---|---|---|---|---|
| | Charge | Discharge | Capacity | Capacity |
| | Capacity | Capacity | Efficiency | Retention |
| [symbol] | (mAh/g) | (mAh/g) | (%) | (%) |
| Example 1 | 1,484 | 1,335 | 90.0 | 99.5 |
| Example 2 | 1,490 | 1,329 | 89.2 | 99.4 |
| Example 3 | 1,524 | 1,340 | 87.9 | 99.5 |
| Example 4 | 1,503 | 1,332 | 88.6 | 99.6 |
| Example 5 | 1,408 | 1,264 | 89.7 | 98.7 |
| Example 6 | 1,525 | 1,294 | 84.9 | 96.2 |
| Example 7 | 1,420 | 1,241 | 87.4 | 99.2 |
| Comparative | 1,488 | 1,325 | 89.0 | 99.3 |
| Example 1 | | | | |
| Comparative | 1,494 | 1,303 | 87.2 | 99.1 |
| Example 2 | | | | |
| Comparative | 1,588 | 1,315 | 82.8 | 99.6 |
| Example 3 | | | | |

Referring to Tables 1 to 3, in Examples where the anode composition was prepared by adding the predetermined amount of the organic acid to the anode active material having the XPS peak area ratio of 16.0 or less, the viscosity change rates were generally lower than those from Comparative Examples while also reduction the gas generation. Further, the capacity and life-span properties were improved.

In Example 6 where the organic acid content exceeded 1.5 wt % by weight, the initial capacity efficiency and the capacity retention rate were slightly decreased compared to those from other Examples. In Example 7 where the organic acid content was less than 0.5 wt %, the viscosity change rate and the gas generation were slightly increased compared to those from other Examples

What is claimed is:

1. An anode composition for a lithium secondary battery, comprising:
a metal-doped silicon oxide (SiOx, 0<x<2) particle satisfying Equation 1 and including a metal silicate area on a surface portion thereof; and
an organic acid:
A/B<16.0 [Equation 1]
wherein, in Equation 1, A is a peak area corresponding to a metal silicate from a deconvolution of an Si2p spectrum measured by an X-ray Photoelectron Spectroscopy (XPS) analysis on the metal-doped silicon oxide (SiOx, 0<x<2) particle,
B is a peak area corresponding to silicon dioxide from the deconvolution of the Si2p spectrum measured by the XPS analysis on the metal-doped silicon oxide (SiOx, 0<x<2) particle, and
a peak area at 102 eV corresponds to the peak area of the metal silicate and a peak area at 104 eV corresponds to the peak area of silicon dioxide.

2. The anode composition for a lithium secondary battery of claim 1, wherein a metal doped to the metal-doped silicon oxide (SiOx, 0<x<2) particle includes at least one selected from the group consisting of lithium, magnesium, calcium and aluminum.

3. The anode composition for a lithium secondary battery of claim 1, wherein the organic acid includes at least one selected from the group consisting of maleic acid, palmitic acid, tartaric acid, acetic acid, methacrylic acid, glycolic acid, oxalic acid, glutaric acid and fumaric acid.

4. The anode composition for a lithium secondary battery of claim 1, wherein a content of the organic acid is from 0.5 wt % to 1.5 wt % based on a total weight of the anode composition.

5. The anode composition for a lithium secondary battery of claim 4, wherein the content of the organic acid is from 0.6 wt % to 1.2 wt % based on the total weight of the anode composition.

6. The anode composition for a lithium secondary battery of claim 1, wherein a pH of the anode composition is from 7.0 to 9.5.

7. The anode composition for a lithium secondary battery of claim 1, further comprising a binder and a thickener.

8. The anode composition for a lithium secondary battery of claim 7, wherein the binder comprises at least one of an acrylic binder and styrene-butadiene rubber (SBR).

9. The anode composition for a lithium secondary battery of claim 7, wherein the thickener includes carboxymethyl cellulose (CMC).

10. A method of preparing an anode composition for a lithium secondary battery, comprising:
preparing a metal-doped silicon oxide (SiOx, 0<x<2) particle;
mixing an organic acid with the metal-doped silicon oxide (SiOx, 0<x<2) particle; and
mixing a binder and a thickener to the metal-doped silicon oxide (SiOx, 0<x<2) particle mixed with the organic acid.

11. The method of claim 10, further comprising performing an X-ray Photoelectron Spectroscopy (XPS) analysis on the metal-doped silicon oxide (SiOx, 0<x<2) particle,
wherein mixing the organic acid is performed when the metal-doped silicon oxide (SiOx, 0<x<2) particle satisfies Equation 1:
A/B<16.0 [Equation 1]
wherein, in Equation 1, A is a peak area corresponding to a metal silicate from a deconvolution of an Si2p spectrum measured by the XPS analysis on the metal-doped silicon oxide (SiOx, 0<x<2) particle,
B is a peak area corresponding to silicon dioxide from the deconvolution of the Si2p spectrum measured by the XPS analysis on the metal-doped silicon oxide (SiOx, 0<x<2) particle, and
a peak area at 102 eV corresponds to the peak area of the metal silicate and a peak area at 104 eV corresponds to the peak area of silicon dioxide.

12. The method of claim 10, wherein preparing the metal-doped silicon oxide (SiOx, 0<x<2) particle does not comprises an acid washing.

13. An anode for a lithium secondary battery, comprising:
an anode current collector; and
an anode active material layer formed by coating an anode composition on at least one surface of the anode current collector,
wherein the anode composition comprises a metal-doped silicon oxide (SiOx, 0<x<2) particle satisfying Equation 1 and including a metal silicate area on a surface portion thereof, and an organic acid:
A/B<16.0 [Equation 1]
wherein, in Equation 1, A is a peak area corresponding to a metal silicate from a deconvolution of an Si2p spectrum measured by an X-ray Photoelectron Spectroscopy (XPS) analysis on the metal-doped silicon oxide (SiOx, 0<x<2) particle,
B is a peak area corresponding to silicon dioxide from the deconvolution of the Si2p spectrum measured by the XPS analysis on the metal-doped silicon oxide (SiOx, 0<x<2) particle, and
a peak area at 102 eV corresponds to the peak area of the metal silicate and a peak area at 104 eV corresponds to the peak area of silicon dioxide.
